(19) United States
(12) Patent Application Publication
(10) Pub. No.: US 2004/0014499 A1
(43) Pub. Date: Jan. 22, 2004

(54) Determining signal direction in radio system

(76) Inventors: Jyri Hamalainen, Oulu (FI); Esa Tiirola, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/375,054

(22) Filed: Feb. 28, 2003

(30) Foreign Application Priority Data
Mar. 1, 2002 (FI) 20020400

(51) Int. Cl. H04M 1/00

(52) U.S. Cl. 455/561; 455/562.1

(57) ABSTRACT

The invention relates to determining the direction of a received signal in a radio system. A variable describing the angular speed of a terminal (402) in relation to a base station (400) is determined in the radio system. An estimator of the base station performs averaging filtering on the power of a received signal, on the receiving direction or on both. Information on the variable describing the angular speed of the terminal (402) is fed into the estimator, which changes at least one parameter of averaging filtering according to the variable describing the angular speed of the terminal (402). The estimator determines the direction of the received signal utilizing the signal power or receiving direction filtered with averaging filtering or both.

### BACKGROUND OF THE INVENTION

1. Field of the Invention

The invention relates to a method of determining a signal direction and to a radio system implementing the method. In particular, the method relates to determining the direction of a signal to be received.

2. Description of the Related Art

In the CDMA (Code Division Multiple Access), the user's narrow-band data signal is modulated into a relatively wide band by a spreading code with a wider band than the data signal. In a WCDMA radio system (Wide-band CDMA), the bandwidth is considerably larger so as to provide more versatile services for users in the existing mobile communication networks.

In the WCDMA radio system, in particular, a signal can be received and transmitted by an antenna array which comprises several separate antenna elements (which are far from one another). Signals can also be transmitted and received by an antenna array, such as a ULA antenna (Uniform Linear Array), where antenna elements are close to one another (e.g. at a distance corresponding to half of the wavelength of radio frequency radiation). For example, when six antenna elements located close to one another are used, it is feasible to achieve e.g. six transmitting and receiving beams which are fixedly directed in different directions. Phasing of the signals received by different antenna elements can also be changed with respect to one another in a desired manner, in which case one or more beams formed by the antenna array can be provided with the desired direction and shape. In practice, phasing can be performed by modifying the phases of radio frequency signals or by multiplying the digital base band antenna signal of each antenna element by complex factors which shape the antenna pattern.

The direction of a received signal can be determined on the basis of the power received by different receiving antennas. This determination can be carried out by the EVD method (Eigen Value Composition) or an algorithm based on the subspace, for instance. The MUSIC algorithm (MUltiple Slgnal Classification) known per se is the simplest and most commonly used algorithm based on the subspace.

Problems are, however, associated with the determination of the receiving direction. The momentary power levels of a received signal vary considerably. If the receiving direction is determined on the basis of momentary values, the deviation of each measurement from the previous measurement may be significant, which impairs the radio system operation particularly when fixed transmission and receiving beams are used. This leads to the fact that the transmitter has to be unnecessarily frequently switched from one transmitting beam to another when the receiving direction changes more than the aperture of the transmitting beam. On the other hand, the changing of the transmitting beam increases the amount of signalling, which further deteriorates the function of the system. In addition, when a signal is directed from a base station to a terminal by means of the determined receiving direction, the average power at the terminal decreases due to the wrong alignment, which makes the use of more effective methods for shaping the radiation pattern, such as null steering, impossible.

It has been possible to reduce the problems of prior art solutions to some extent by filtering the powers of received signals. In spite of filtering, two directions determined successively may still deviate a lot from each other and the determined receiving directions do not necessarily follow accurately enough the real movement of a terminal, which is not sufficient for diminishing the above-mentioned problems.

### SUMMARY OF THE INVENTION

The object of the invention is to provide an improved method of determining the direction of a signal and a radio system according to the method so as to provide the signal direction more reliably. This is achieved by a method of determining the direction of a signal in a radio system, the method comprising receiving a signal transmitted by a first transceiver by at least two antenna elements of an antenna array of a second transceiver which are used to form at least two receiving beams with different directions; determining signal power values in at least two different receiving beams and a preliminary receiving direction of the received signal as properties of the received signal. The method further comprises determining a variable which describes the angular speed of the first transceiver with respect to the second transceiver; performing averaging filtering on at least one of the determined properties, and changing at least one parameter of averaging filtering according to the variable describing the angular speed of the first transceiver; and determining the direction of the received signal utilizing at least one property obtained through averaging filtering.

The invention also relates to a method of directing a receiving beam, the method comprising receiving a signal transmitted by a first transceiver by at least two antenna elements of an antenna array of a second transceiver which form at least two receiving beams with different directions; determining signal power values in at least two different receiving beams and a preliminary receiving direction of the received signal as properties of the received signal. The method further comprises determining a variable which describes the angular speed of the first transceiver with respect to the second transceiver; performing averaging filtering on at least two of the determined properties, and changing at least one parameter of averaging filtering according to the variable describing the angular speed of the first transceiver; determining the direction of the received signal utilizing at least one property obtained through averaging filtering; and directing at least one receiving beam of the second transceiver by means of the determined receiving direction.

The invention further relates to a radio system which comprises at least one base station and several terminals; the base station comprises an antenna array, which includes at least two antenna elements arranged to form at least two receiving beams with different directions; the terminal is arranged to function as the transmitter of the signal used in direction determination, the base station is arranged to function as the receiver of the signal used in direction determination, and determine signal power values in at least two receiving beams and a preliminary receiving direction of the signal as properties of the direction determining signal received by receiving beams with different directions. The radio system is further arranged to determine a variable which describes the angular speed of the terminal with respect to the base station; the radio system comprises an estimator which performs averaging filtering on at least one of the determined properties; the estimator is arranged to receive information on the variable describing the angular speed of the terminal; the estimator is arranged to change at least one parameter of the terminal according to the variable describing the angular rate during the averaging filtering, and the estimator is arranged to determine the direction of the received signal utilizing at least one property obtained through averaging filtering.

Preferred embodiments of the invention are disclosed in the dependent claims.

The invention is based on the idea that the state of movement of the mobile transceiver transmitting the received signal is also taken into account in the determination of the receiving direction, which is based on the levels of the signals received by different receiving beams. Also, the state of movement of a mobile transceiver is taken into account in the determination of the transmitting direction when signals are transmitted to a mobile transceiver.

The method and arrangement of the invention provide several advantages. Determination of the receiving direction becomes more reliable and accurate, and the dispersion of the determined receiving directions remains small, which improves the connection quality and reduces the amount of signalling.

### BRIEF DESCRIPTION OF THE DRAWINGS

The invention will now be described in greater detail by means of preferred embodiments, with reference to the accompanying drawings, in which

FIG. 1 is a simplified block diagram illustrating the structure of radio systems,

FIG. 2 illustrates a transceiver with fixed receiving beams,

FIG. 3 illustrates a transceiver with receiving beams that can be shaped with weighting coefficients,

FIG. 4A illustrates determining a receiving direction,

FIG. 4B illustrates directing of receiving beams,

FIG. 5 illustrates a transceiver with fixed transmitting beams,

FIG. 6 illustrates a transceiver with transmitting beams which are shaped by weighting coefficients,

FIG. 7A illustrates null steering of receiving beams,

FIG. 7B illustrates null steering of transmitting beams,

FIG. 8 illustrates the effective error of the direction of a received signal as a function of the effective length of averaging filters when the transceiver transmitting a signal moves slowly, and

FIG. 9 illustrates the effective error of the direction of a received signal as a function of the effective length of averaging filters when the transceiver transmitting a signal moves fast.

### DETAILED DESCRIPTION OF THE PREFERRED EMBODIMENT(S)

The embodiments to be described are applicable to telecommunication systems. An example of such a telecommunication system is a wideband WCDMA radio system which utilizes wideband spread spectrum data transmission. In the following, embodiments will be described using GPRS and GSM radio systems as examples, without limiting the invention thereto, which is obvious to a person skilled in the art.

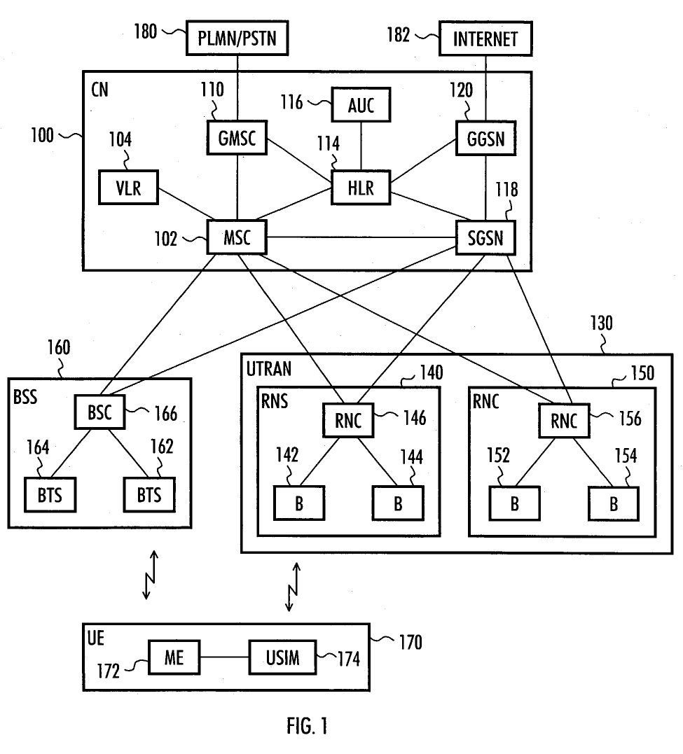

Examine first FIG. 1, which illustrates the structure of radio systems in a simplified manner at the level of network elements. The structure and functions of network elements are not described in detail as they are generally known per se. The radio-independent layer of the telecommunication system is represented by a core network (CN) 100. Radio systems are represented by a first radio system, i.e. a radio access network UTRAN 130, and a second radio system, i.e. base station system BSS 160. The term UTRAN is short for UMTS Terrestrial Radio Access Network, i.e. the radio access network 130 is implemented by wideband code division multiple access (WCDMA) technology. FIG. 1 also shows user equipment 170. The base station system 160 is implemented by time division multiple access (TDMA) technology.

On a general level, the radio system can also be defined to comprise user equipment, which is also known as a subscriber terminal and mobile phone, for instance, and a network part, which comprises the radio access network for the fixed infrastructure of the radio system or base station system.

The structure of the core network 100 corresponds to a combined structure of the GSM (Global System for Mobile Communication) and GPRS (General Packet Radio Service) systems. The GSM network elements are responsible for establishing circuit-switched connections, and the GPRS network elements are responsible for establishing packet-switched connections; some of the network elements are, however, in both systems.

A mobile services switching center (MSC) 102 is the center point of the circuit-switched side of the core network 100. The same mobile services switching center 102 can be used to serve the connections of both the radio access network 130 and the base station system 160. The tasks of the mobile services switching center 102 include: switching, paging, user equipment location registration, handover management, collection of subscriber billing information, encryption parameter management, frequency allocation management, and echo cancellation. The number of mobile services switching centers 102 may vary: a small network operator may only have one mobile services switching center 102, but in large core networks 100, there may be several.

Large core networks 100 may have a separate gateway mobile services switching center (GMSC) 110 which takes care of circuit-switched connections between the core network 100 and external networks 180. The gateway mobile services switching center 110 is located between the mobile services switching centers 102, 106 and the external networks 180. An external network 180 can be for instance a public land mobile network (PLMN) or a public switched telephone network (PSTN).

A home location register (HLR) 114 contains a permanent subscriber register, i.e. the following information, for instance: an international mobile subscriber identity (IMSI), a mobile subscriber ISDN number (MSISDN), an authentication key, and when the radio system supports GPRS, a packet data protocol (PDP) address.

A visitor location register (VLR) 104 contains roaming information on user equipment 170 in the area of the mobile services switching center 102. The visitor location register 104 contains almost the same information as the home location register 114, but in the visitor location register 104, the information is kept only temporarily.

An authentication center (AuC) 116 is always physically located in the same place as the home location register 114, and contains a subscriber authentication key Ki, CK (Ciphering Key) and a corresponding IMSI.

The network elements shown in FIG. 1 are functional entities whose physical implementation may vary. Usually, the mobile services switching center 102 and visitor location register 104 form one physical device, and the home location register 114, equipment identity register 112 and authentication center 116 form another physical device.

A serving GPRS support node (SGSN) 118 is the center point of the packet-switched side of the core network 100. The main task of the serving GPRS support node 118 is to transmit and receive packets with the user equipment 170 supporting packet-switched transmission by using the radio access network 130 or the base station system 160. The serving GPRS support node 118 contains subscriber and location information related to the user equipment 170.

A gateway GPRS support node (GGSN) 120 is the packet-switched side counterpart to the gateway mobile services switching center 110 of the circuit-switched side with the exception, however, that the gateway GPRS support node 120 must also be capable of routing traffic from the core network 100 to external networks 182, whereas the gateway mobile services switching center 110 only routes incoming traffic. In our example, external networks 182 are represented by the Internet.

The radio access network 130 is made up of radio network subsystems RNS 140, 150. Each radio network subsystem 140, 150 is made up of radio network controllers RNC 146, 156 and B nodes 142, 144, 151, 154. A B node is a rather abstract concept, and often the term base transceiver station is used instead of it.

The radio network controller 146 controls the B nodes 142, 144 under its control. In principle, the equipment implementing the radio part and the related functions should be on the B nodes 142, 144 and the management devices in the radio network controller 146.

The radio network controller 146 is responsible for the following tasks, for instance: radio resource management of the B node 142, 144, intercell handovers, frequency control, i.e. frequency allocation to the B nodes 142, 144, management of frequency hopping sequences, time delay measurement on the uplink, implementation of the operation and maintenance interface, and power control.

The B node 142, 144 contains at least one transceiver which implements the WCDMA interface. Typically the B node serves one cell, but also a solution in which the B node serves several sectored cells is feasible. The diameter of a cell can vary from a few meters to tens of kilometers. The tasks of the B node 142, 144 include: calculation of timing advance (TA), uplink measurements, channel coding, encryption, decryption, and frequency hopping.

The second radio system, i.e. the base station system 160, consists of a base station controller (BSC) 166 and base transceiver stations (BTS) 162, 164. The base station controller 166 controls the base transceiver station 162, 164. In principle, the aim is that the devices implementing the radio path and their functions reside in the base transceiver station 162, 164, and control devices reside in the base station controller 166. The base station controller 166 is substantially responsible for the same tasks as the radio network controller.

The base transceiver station 162, 164 contains at least one transceiver which provides one carrier, i.e. eight time slots, i.e. the transceiver implements eight physical channels on each carrier. Typically one base transceiver station 162, 164 serves one cell, but also a solution in which one base transceiver station 162, 164 serves several sectored cells is feasible. The base transceiver station 162, 164 also comprises a transcoder which converts the speech coding format used in the radio system to that used in the public switched telephone network. In practice, the transcoder is, however, physically located in the mobile services switching center 102. The base transceiver station 162, 164 is responsible for the same tasks as the B node.

The user equipment 170 comprises two parts: mobile equipment (ME) 172 and UMTS subscriber identity module (USIM) 174. The USIM 174 includes information on the user and particularly on data security, e.g. an encryption algorithm. The user equipment 170 contains at least one transceiver for establishing a radio link to the radio access network 130 or base station system 160. The user equipment 170 can contain at least two different subscriber identity modules. In addition, the user equipment 170 contains an antenna, user interface and battery. Today, there are different types of user equipment 170, for instance equipment installed in cars and portable equipment. In this application, the user equipment 170 is typically a transmitter (a first transceiver, mobile transceiver). A signal transmitted by the transceiver is received by a receiver, which also determines the direction of the signal. In the present application, the base station or the B node is typically a receiver (a second transceiver) which determines the direction of the signal it has received. In the WCDMA radio system, the terminal transmits a signal on a DPCCH channel (Dedicated Physical Control Channel), the signal being I/Q multiplexed (In-phae/Quadrature) with a dedicated data channel. The DPCCH channel includes a time-multiplexed pilot signal, which is used at the base station receiver e.g. in channel estimation, SIR estimation (Signal-to-Interference Ratio), direction estimation, etc. Furthermore, the terminal transmits power control command signals to the base station and possibly other control signals which can be employed in the solution described. Thus it is obvious to a person skilled in the art that the transmitter according to the application may also function as a receiver and the receiver as a transmitter.

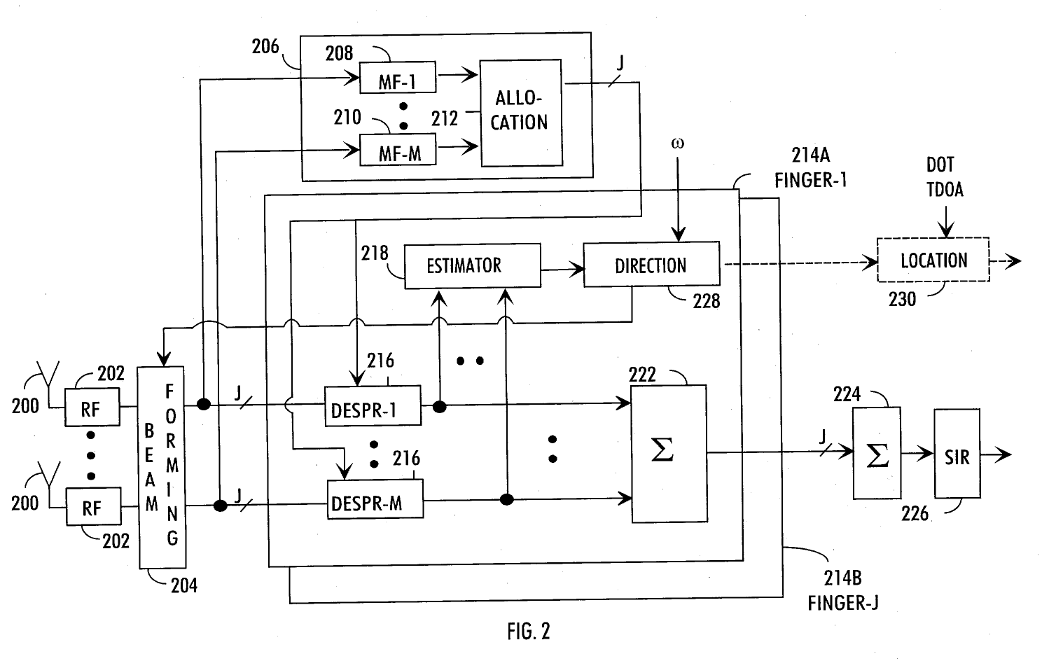

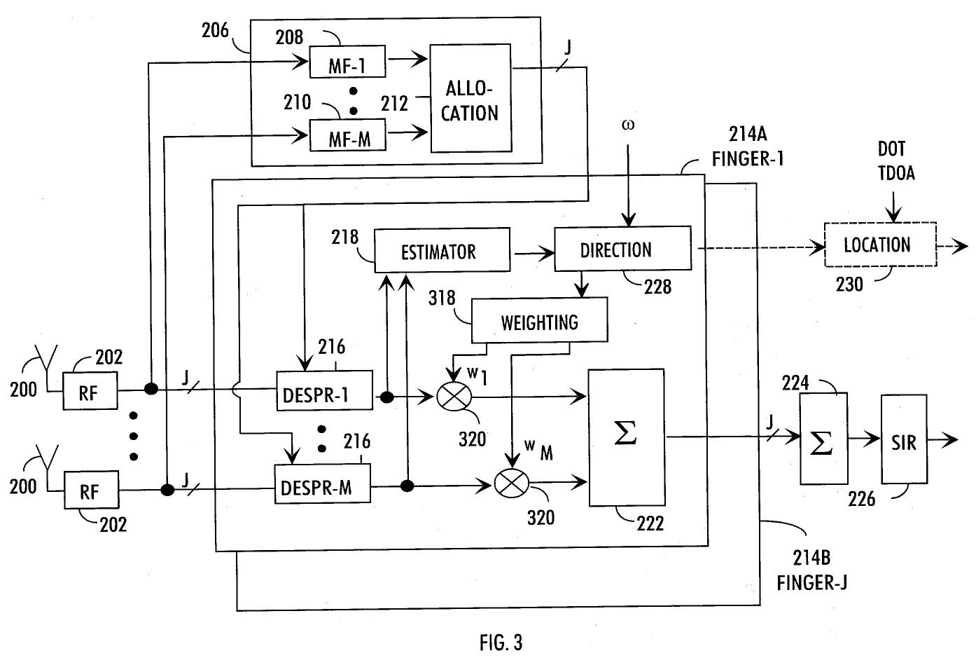

Examine now FIGS. 2 and 3 which describe a receiver used in CDMA reception. The receiver includes a smart antenna whose receiving beams have a fixed directed. The receiving beams are preferably orthogonal Fourier beams but also other non-orthogonal antenna beams are feasible. In FIG. 2, a multi-path propagated signal used in direction determination is received by antenna elements 200. The number of antenna elements is M. FIG. 2 illustrates only two antenna elements but two or more antenna elements can be employed. For example, in an ULA antenna array, there may be six antenna elements which can produce six receiving beams, for example. The signal received from each antenna element 200 is converted in radio frequency parts (which are not shown in FIG. 2) into the base band.

The received signal, which is used in the determination of the incoming direction of the signal, propagates into radio frequency parts 202, where the radio frequency signal is mixed into the base band. From the radio frequency parts 202, the signal propagates to a beam-forming block 204, from which the signal is further supplied to a delay estimator 206, which comprises an adapted filter 208 to 210 for each antenna element/beam. The delays of the multi-path propagated signal components of the received signal are retrieved in the delay estimator 206, and the propagation time of the signal can also be determined. On the basis of calculated correlations, an allocator 212 provided in the delay estimator selects the delays at which despreading means 216 of rake branches 214A to 214B perform despreading. In this example, the number of allocated rake fingers 214A to 214B is J. Each rake finger 214A to 214B processes the same number of multi-path propagated signal components at a certain code delay.

Each rake branch 214A to 214B includes a channel estimator 218, where a channel estimate matrix H related to the received signal is determined. The matrix includes a row for each receiving beam, including the channel estimates of the signal components which have arrived in the beam concerned at different delays. The channel estimates and the estimated angular speed are fed into a direction estimator 228, which forms the receiving direction of the signal by means of the channel estimates, utilizing the described DoA measurement (Direction of Arrival), which takes the angular speed of the transmitter into account. Block 228 may also have information on the signals' real transmission directions and possible on their levels, too. The estimator 228 controls a forming block 204 of the receiving beam, which phases the received signals, forming a desired number of receiving beams. The allocator 212 is employed to select at least one receiving beam for detection.

An antenna branch adder, which is the last component in the rake branch 214A to 214B, combines weighted signal components into one signal. The receiver further comprises a rake branch adder 224, which combines signals of rake branches 214A to 214B functioning at different delays into one sum signal. Signals can be combined for detection applying the MRC principle (Maximum Ratio Combining), for example.

The sum signal, like a single signal, can be further supplied to an estimator 226 of the signal/interference ratio where the signal/interference ration of the channel or sum channel concerned is estimated. The signal-to-interference ratio obtained for the channel can be used to control the power control of a closed loop, for instance.

FIG. 3 is similar to FIG. 2 except that in this solution receiving beams are shaped by phasing the signals received by different receiving beams with respect to one another by means of weighting coefficients. A component 318 for determining weighting coefficients forms complex weighting coefficients w1-w_{M} for the signals received by different antenna elements 200 by means of the receiving direction determined in the estimator 228. This enables user-specific shaping of the receiving beam. The shape, number and particularly the direction of receiving beams can be changed in a desired manner by multiplying the signals arriving from different antenna elements 200 by different weighting coefficients w1-w_{M} in multipliers 320. Phasing of the received signals can also be performed between the antenna elements 200 and the radio frequency parts 202.

The solution of both FIG. 2 and FIG. 3 can be utilized in determining the transmitter location. The distance of the transmitter from the receiver can be determined using the signal propagation time and TOA measurement (Time Of Arrival) in a location determining block 230. Since the direction from which the signal transmitted by the transmitter was received can also be determined in block 228 employing the present solution, the transmitter location can be determined in the same way as the location of a point in a polar system of coordinates. Also, TDOA measurement (Time Difference of Arrival) known per se can be utilized in location determination. This measurement can also be used to determine the distance of the transmitter from the receiver.

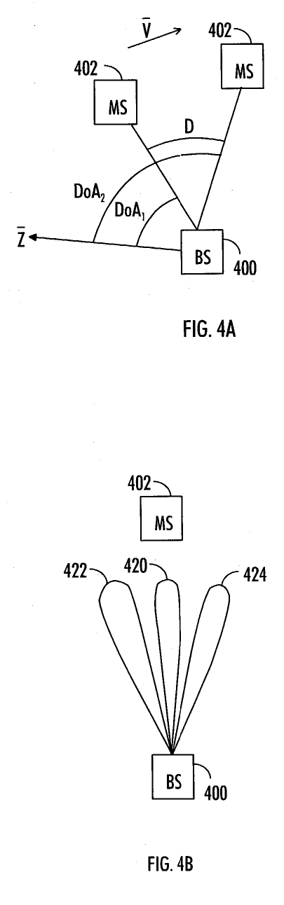

Examine now determination of the receiving direction described in FIG. 4. A base station or B node of a radio system functions as a receiver 400 and a terminal functions as the transmitter 402 of received signals. The antenna elements can form M orthogonal receiving beams, where M is at least two. The channel estimates formed by channel estimators 218 and 318 of FIG. 2 and 3 from the signal received by different antenna beams can be presented as a channel matrix H, whose general form is H=[h₁ . . . h_{L}]^{T}εC^{M×L}, where h₁, . . . ,h_{M} are channel estimate vectors related to different receiving antenna elements. For example, h₁=[h₁₁, . . . h_{1L}]^{T}, where h₁₁ is the first temporal tap of the channel estimate, i.e. the tap corresponding to the shortest delay, and h_{L} is the last tap of the channel estimate, i.e. the tap corresponding to the longest delay. In that case L denotes the number of multipaths of the signal. The channel estimate matrix H can thus be expressed as follows:

$$H = [ \begin{matrix}{h}_{11} & {h}_{12} & Λ & {h}_{1 L} \\ {h}_{21} & {h}_{22} & Λ & {h}_{2 L} \\ M & & O & M \\ {h}_{M1} & {h}_{M2} & Λ & {h}_{M L}\end{matrix} ] \qquad ( 1 )$$

The channel estimate H can be used to determine the normalized power pₘ of the signal received by the m^{th} receiving beam as follows, for example:

$${p}_{m} = \frac{{\sum }_{k = 1}^{L} {\vert {h}_{mk} \vert}^{2}}{{\sum }_{l = 1}^{M} {\sum }_{k = 1}^{L} {\vert {h}_{lk} \vert}^{2}} , \qquad ( 2 )$$

where pₘ is the power expressing the signal level,

$${\sum }_{k = 1}^{L} {\vert {h}_{mk} \vert}^{2}$$

is the sum of the root-mean-square values of the channel estimates of the m^{th} receiving beam, and

$${\sum }_{l = 1}^{M} {\sum }_{k = 1}^{L} {\vert {h}_{lk} \vert}^{2}$$

is the sum of the root-mean-square values of the channel estimates of all paths of all antenna beams. The channel estimates, which may be indeterminable e.g. due to the fact that a rake branch has not been allocated, are set to value 0. The normalized signal power pₘ of each beam is filtered using averaging filtering as follows, for example:

\overline{p}ₘ=αₚpₘ+(1−αₚ)\overline{p}_{m,OLD}, (3)

where \overline{p}ₘ is the filtered value of signal power, αₚ is a forgetting factor used as a filtering parameter, and \overline{p}_{m,OLD} is a previous result of this iterative filtering. The forgetting factor αₚ, which functions as a weighting coefficient, determines the duration of influence. The duration of influence corresponds to the filtering time or, in an FIR embodiment (Infinite Impulse Response), to the number N of taps in the filter. For example, αₚ may be 1/60=1/(15·4), i.e. the duration of filtering time is 4 frames. Since one WCDMA frame may include 15 time slots and the DoA estimate is updated once in each time slot, four frames include 60 time slots, i.e. the forgetting factor will be 1/60 according to the example. In that case, it can be said that the duration of influence αₚ is four frames (or to be more precise, approximately four frames). When filtering is started, the value of the previous result \overline{p}_{m,OLD} can be freely selected between 0 and any other value, for example. After this, a temporary receiving direction DoA_{TEMP} is formed by adding the power \overline{p}ₘ of the averaged signal of at least two different beams with the products/inputs of the directions θₘ of the corresponding beams as follows, for instance:

DoA_{TEMP}

$${DoA}_{TEMP} = {\sum }_{m = 1}^{M} {\overline{p}}_{m} {θ}_{m} \qquad ( 4 )$$

The direction θₘ is the fixed direction of the receiving beam, which is a known variable. The new temporary direction DoA_{TEMP} formed is compared to the previous direction of arrival DoA_{OLD} as follows, for example:

Δ=|DoA_{TEMP}−DoA_{OLD}|, (5)

where Δ is the deviation of the new direction of arrival from the old direction of arrival. If the deviation Δ is greater than a predetermined maximum deviation Amax, the value of the maximum deviation Δ=Δₘₐₓ is set using the deviation Δ. Otherwise the value calculated as difference remains as the value of deviation Δ. Finally, a new direction of arrival DoA is formed by adding the deviation Δ to the direction of arrival DoA_{OLD} determined earlier or by subtracting the deviation Δ from the direction of arrival DoA_{OLD} defined earlier in the following manner, for example:

DoA=DoA_{OLD}+Δ·sign(DoA_{OLD}−DoA_{TEMP}), (6)

Where sign( ) means a sign function which determines the sign (positive or negative) of the difference between the directions of arrival. The direction of arrival DoA means a direction with respect to a known direction \overline{Z}, which is the normal direction of an antenna array, for example.

The solution described will now be examined more closely utilizing also FIG. 4A. First, a variable describing the angular speed of the transmitter 402 transmitting the received signal is to be determined in relation to the receiver 400. The variable describing the angular speed can be determined in various ways. One way is to determine the highest speed at which the transmitter 402 may move in the coverage area of the of the receiver 400. In the radio system, this area is a cell of a base station or B node or a sector of a cell. The highest speed can be determined according to the highest speeds used on railways or motorways, for example. Other feasible ways of determining the angular speed include measuring the transmitter speed before connection establishment or during connection establishment by Doppler measurement or in another way known per se.

It is assumed that the maximum speed vₘₐₓ of the transmitter 402 is determined or measured, and this speed is used for determining the maximum angular speed ωₘₐₓ of the transmitter 402. In that case, it is assumed that the distance R of the transmitter 402 from the receiver 400 is as short as possible because this corresponds to the worst possible situation. In that case, the transmitter moves the distance vₘₐₓ·T_{N} during T_{N} filtering. The maximum angular speed will thus be

ωₘₐₓ=2·arctan[vₘₐₓ·T_{N}/(2R)]≈vₘₐₓ·T_{N}/R. (7)

In the present solution, after the angular speed of the transmitter has been estimated, the coefficients of the averaging filtering of the received signals are modified according to the angular speed determined. In that case, the coefficients αₚ and (1−αₚ) in front of terms pₘ and \overline{p}_{m,OLD} in formula \overline{p}ₘ=αₚpₘ+(1−αₚ)\overline{p}_{m,OLD} are modified by changing the value of parameter αₚ according to the estimated angular speed of the transmitter. Parameter αₚ affects the duration of filtering (the number of filtering factors in the case of a FIR filter) and weighting. Filtering can be performed either per frames or per time slots. In a WCDMA radio system, there are 1500 time slots per second. After this, the direction of the received signal can be determined utilizing the final result of \overline{p}ₘ of averaging filtering in accordance with formulae (4), (5) and (6).

In the solution described, the temporary direction of arrival DoA_{TEMP} can also be subjected to averaging filtering. In that case, the averaged temporary direction of arrival \overline{DoA}_{TEMP} can be determined e.g. as follows in the present solution:

\overline{DoA}_{TEMP}=α_{d}·DoA_{TEMP}+(1−α_{d})\overline{DoA}_{TEMP,OLD}, (8)

where \overline{DoA}_{TEMP,OLD} is the previous averaged temporary direction of arrival and ad is a filtering parameter which affects the duration of filtering and weighting. Instead of the temporary direction of arrival \overline{DoA}_{TEMP,OLD}, it is also possible to use the previous direction of arrival DoA obtained by formula (6). In the present solution, weighting values of the averaging are changed in the same manner as in averaging of the signal power, i.e. the coefficients ad and (1−α_{d}) in front of terms DoA_{TEMP} and \overline{DoA}_{TEMP,OLD} are modified by changing the value of parameter ad according to the estimated angular speed of the transmitter. After this, the direction of the received signal can be determined utilizing the final result of averaging filtering according to formula DoA=DoA_{OLD}+Δ·sign(DoA_{OLD}−\overline{DoA}_{TEMP}), for example.

The parameters αₚ or α_{d} shown are related to filtering which occurs per time slots. In that case parameter αₚ, for example, receives value αₚ=1/(15·N), where N is the duration of influence expressed as frames of the WCDMA radio system. In general averaging filtering, the change of a filtering parameter is related to a change in the number of elements to be averaged in the filtering algorithm or to a change of the coefficients of the elements or to both. This appears clearly when we examine an algorithm which is used for forming a conventional average, which can be expressed as follows:

$${\overline{p}}_{m} = \frac{1}{K} {\sum }_{i = 1}^{K} ( {g}_{i} \cdot {p}_{i} ) , \qquad ( 9 )$$

where gᵢ is a coefficient used as a parameter in filtering, pᵢ is the power of a received signal, K is the number of elements to be averaged which is used as another parameter in filtering, and I is the index of elements to be summed.

The deviation Δ is determined as a difference between the present and the previous averaged temporary direction of arrival as follows

Δ=|\overline{DoA}_{TEMP}−\overline{DoA}_{TEMP,OLD}| (10)

If the deviation Δ of the direction of arrival is greater than the maximum deviation Δₘₐₓ, the value of the maximum deviation Δ=Δₘₐₓ is set as the value of deviation Δ.

In the present solution, the maximum deviation Δₘₐₓ of the direction of arrival also depends on the determined angular speed ω of the transmitter, which can be expressed mathematically as Δ=f(ω), where f(ω) is a function of the angular speed ω. If the transmitter speed cannot be measured before a connection is established, the transmitter speed can be assumed to be the highest possible one in the coverage area of the receiver. In that case, the maximum deviation Δₘₐₓ can be formed as follows:

Δₘₐₓ=a·ωₘₐₓ, (11)

where a is a constant greater than 1 so that the receiving beam can also follow a fast movement of the transmitter, e.g. between 2 and 10. After a connection has been established between the transmitter and the receiver, the angular speed of the transmitter can be estimated either by means of the present solution or by means of a prior art solution for estimating the movement of a terminal. Since the angular speed of the transmitter can be estimated according to the real movement of the transmitter, the maximum deviation Δₘₐₓ of the receiving angle can be reduced according to the angular speed of the transmitter as much as desired.

The feasible speeds of the transmitter can be divided into a desired number of classes, which reduces the number of necessary calculations and simplifies it. The division can be performed as equal division or unequal division. When P speed classes are used, the maximum deviation Δ_{k,max} can be defined as divided into unequal slots in each angular speed class as follows, for instance:

Δ_{k,max}=Δₘₐₓ/2^{P-k}, (12)

where k=1, 2, . . . P. The general principle of the present solution is that the product of the maximum deviation Δₘₐₓ and the filtering time T_{N} should be constant, i.e. Δₘₐₓ·T_{N}=b, where the filtering time T_{N} corresponds to the number N of taps in the IIR filter. Constant b is greater than 1, e.g. 16, so that the receiving beam can also follow a fast movement of the transmitter. Thus the duration of influence of the averaging IIR filtering will be N=b/Δ, which can be written as follows when expressed according to the speed class

Nₖ=b/Δₖ (13)

In table 1 used as an example, the transmitter's speeds v are divided into 7 different classes, i.e. K=7. The table also shows the maximum deviation angle Δₘₐₓ of the beam corresponding to each speed class, the duration of influence T_{N} of the filter, the time slot-specific filtering parameter αₖₚ, the angular speed ω of the transmitter and the speed v of the transmitter.

TABLE 1
Speed classes

| k | 1 | 2 | 3 | 4 | 5 | 6 | 7 |
|---|---|---|---|---|---|---|---|
| Δₘₐₓ [°/frame] | 8 | 4 | 2 | 1 | 1/2 | 1/4 | 1/8 |
| T_{N} [frames] | 2 | 4 | 8 | 16 | 32 | 64 | 128 |
| αₚ [1/time slot] | 1/30 | 1/60 | 1/120 | 1/240 | 1/480 | 1/960 | 1/1920 |
| ω [°/frame] | 1 | 1/2 | ¼ | 1/8 | 1/16 | 1/32 | 1/64 |
| v [km/h] | 300 | 150 | 75 | 37.5 | 18.75 | 9.375 | 4.6875 |

Table 1 shows an example of how the filtering parameter αₚ can be changed as a function of angular speed ω or according to the angular speed class. The higher the angular speed of the transmitter is, the shorter the duration of influence T_{N} of the filter is. This is implemented by changing the filtering parameter α_{d}. The maximum deviation is proportional to the inverse value of the duration of influence T_{N}. When the angular speed of the transmitter increases, the value of the maximum deviation and the filtering parameter can, according to Table 1, be increased by several classes in one go if the change of the angular speed corresponds to so great a change. On the other hand, when the angular speed of the transmitter decreases, the value of the maximum deviation and the filtering parameter can be decreased by only one class at a time.

The present solution can be illustrated by the following example. Assume that in the coverage area of the receiver the maximum transmitter speed v=300 km/h, which corresponds to 83.3 m/s. Thus the maximum angular speed ωₘₐₓ for the coverage area is obtained by calculating ωₘₐₓ=2·arctan

$$( \frac{83.3 m \text{/} s \cdot 0.01 s}{2 \cdot 50 m} ) \approx$$

1°/frame, when it is assumed that at its closest the transmitter is 50 m away from the receiver. Correspondingly, we obtain as the maximum deviation ΔₘₐₓΔₘₐₓ=8.1°/frame=8°/frame, where value 8 is used as the coefficient a. The maximum deviation Amax can be reduced when the real speed of the transmitter is followed. The maximum deviation in each angular speed class will thus be Δ_{k,max}=Δₘₐₓ/2^{K-k}. If it is noticed that the transmitter belongs to speed class k=3, the maximum deviation will be 2°/frame according to Table 1.

According to the solution described, the transmitting beam is directed or selected by means of the measured direction of arrival. Since the direction of the signal received from the transmitter is determined continuously, a change of the estimated direction is noticed and the angular speed of the transmitter can be estimated by dividing the estimated transition angle by the time used for the transition, for instance.

It is often advantageous to direct three receiving beams towards the direction of the transmitter by directing one beam 420 towards the transmitter 400 and two other beams 422 and 424 towards both sides of the directed beam 420 to the front of the transmitter 400 and behind it, as shown in FIG. 4B.

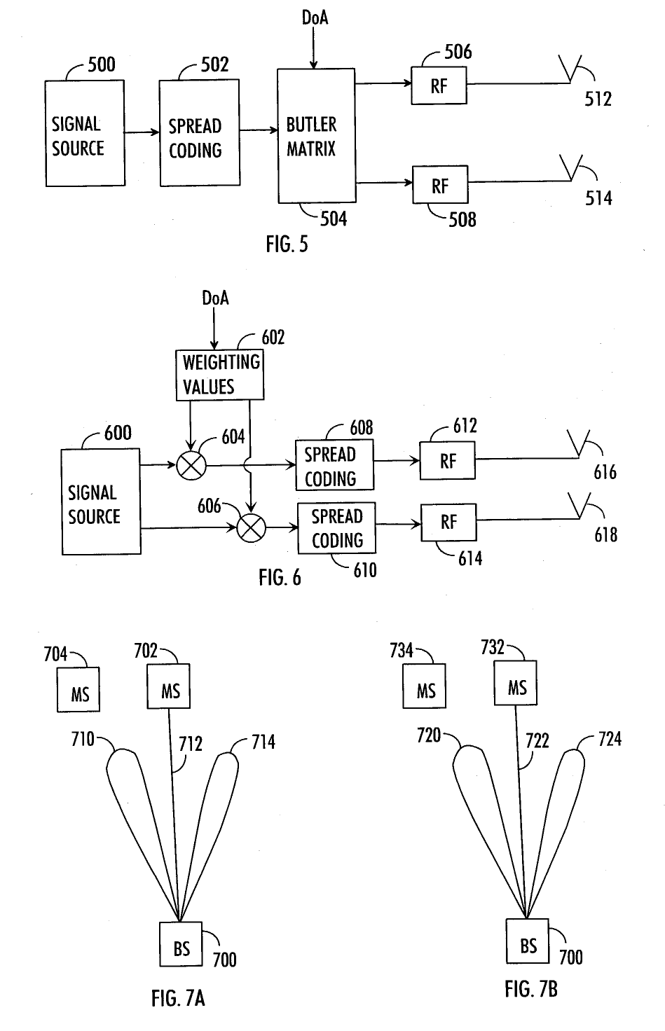

The transmission of signals back from the receiver to the transmitter will be described by means of FIGS. 5 and 6. Fixed transmission beams are used in FIG. 5. A signal coming from a signal source 500 is spread-coded in a spread-coding block 502. The spread coded signal is fed into a beam-forming block 504, into which the determined direction of arrival DoA will also be fed. The beam-forming block may comprise, for example, a ‘Butler matrix’ which phases the signal to be transmitted in a desired manner for different antenna elements. Thus the determined direction of arrival (DoA) is used to select at least one transmitting beam (which is formed by means of the beam-forming block 504), via which the signal is transmitted towards the direction determined on the basis of the direction of arrival. An advantageous situation is often such that the signal transmitted by the transmitter is received by more than one receiving beam but the receiver transmits signals to the transmitter using only one transmitting beam. Finally, the signals intended for different antenna elements are converted into the radio frequency in radio frequency means 506 to 508, and the radio frequency signals propagate to antenna elements, which emit the signal in at least one desired direction. Thus the phasing of an antenna array provides fixed transmitting beams, in which case beams with a desired direction and shape can be selected from among fixed antenna beams.

Shapeable transmitting beams are used in FIG. 6. The signal distributed to different antenna elements from the signal source 600 propagates to multipliers 604 and 606, where the signal is multiplied by complex weighting coefficients w₁-w_{N} formed in weighting coefficient means 602. The determined direction of arrival DoA, by means of which the weighting coefficients are formed, is fed into the weighting coefficient means. The weighting coefficients shape the transmitting antenna pattern in a desired manner. This enables the used of fixed transmitting beams, null steering and user-specific shaping of the transmitting beam, etc. The weighted signals are spread coded in a spread coding block 608 to 610 and converted into the radio frequency in radio frequency means 612 to 614. The spread coding and weighting of signals may also be performed in a reverse order, and spread coding and weighting can also be combined into one multiplication operation. After this, radio frequency signals propagate to antenna elements 616 to 618, which emit the signal in at least one desired direction.

FIGS. 7A and 7B illustrate application of null steering in connection with the solution described. If in the situation shown in FIG. 7A there are one or more interfering transmitters 702 in the coverage area of the receiver 700 and the receiver 700 tries to receive a signal from a desired transmitter 704, at least one receiving beam 710 of the receiver 700 can be directed towards the desired transmitter 704 to a desired extent, but in particular, one tries to direct each null point 712 between the beams 710 and 714 of the receiver 700 as close towards the interfering transmitter 702 as possible. In that case, the receiver 700 receives as small an amount as possible of the power of the interfering signal transmitted by the interfering transmitter 702.

If in the situation shown in FIG. 7B there is at least one transmitter 732 interfered with the transmission of the receiver 700 in the coverage area of the receiver and the receiver tries to transmit a signal to a desired transmitter 734, at least one receiving beam 720 of the receiver 700 can be directed towards the desired transmitter 734 to a desired extent, but in particular each null point 722 between beams 720 and 724 of the receiver 700 is to be directed towards the disturbed transmitter 702. In that case the power of the interfering signal received by the transmitter 732 from the receiver is small.

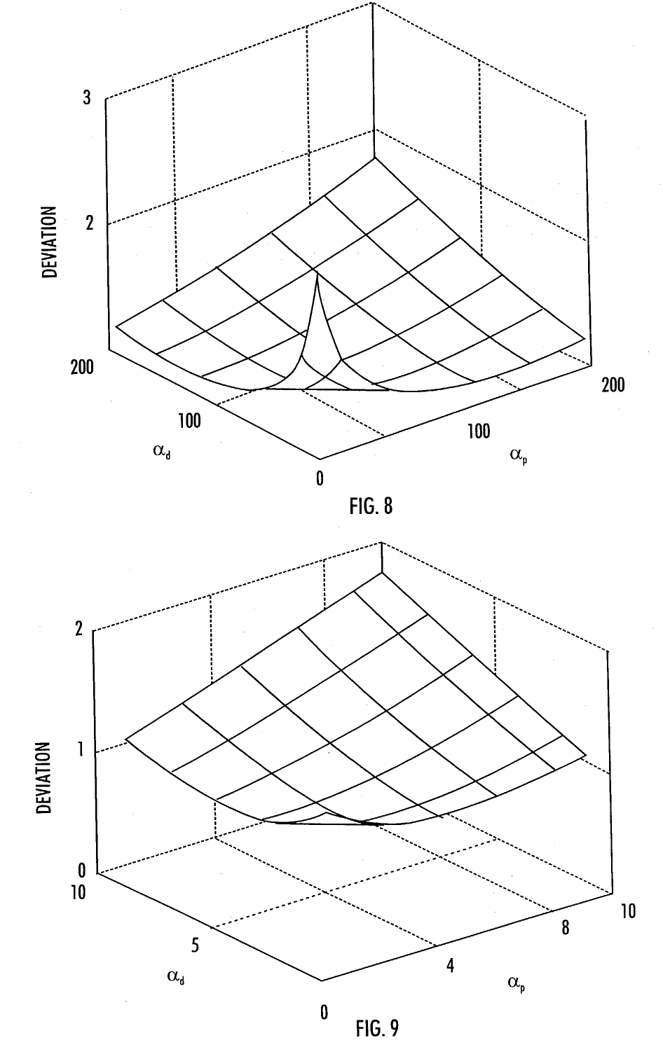

FIG. 8 illustrates the root-mean-square error of the direction of the received signal as a function of the IIR filter length (αₚ) used in filtering the signal power received from the real direction and the IIR filter length (α_{d}) used in filtering the direction of the received signal when the angular speed of the transmitter is 0.5°/s and the assumed real speed is 3 km/h. The length of the IIR filter used in filtering the power of the received signal is proportional to parameter αₚ and the length of the IIR filter used in filtering the direction of the received signal is proportional to parameter α_{d}. In that case the filtering time may be long, which means that the number of filter taps may be as large as 200.

FIG. 9 illustrates a root-mean-square error of the direction of the received signal as a function of the IIR filter length (αₚ) used in filtering the signal power received from the real direction, and the IIR filter length (α_{d}) used in filtering the direction of the received signal when the angular speed of the transmitter is 10°/s and the assumed real speed is 120 km/h. In that case, the filtering time is short (number of filter taps is 10) but the root-mean-square error is smaller than in the case of FIG. 8. It can be seen from FIGS. 8 and 9 that when the length (αₚ) of the IIR filter used in filtering the signal power and the length (α_{d}) of the IIR filter used in filtering the signal direction are the same, the mean-root-square error is the smallest.

The solutions according to the invention can be implemented in respect of digital signal processing, in particular, by ASIC or VLSO circuits, for instance (Application-Specific Integrated Circuit, Very Large Scale Integration). The operations to be performed are preferably implemented as programs based on the microprocessor technology.

Even though the invention was described above with reference to the example according to the enclosed drawings, it is clear that the invention is not limited thereto but it may be modified in various ways within the inventive concept disclosed in the appended claims.

1. A method of determining a signal direction in a radio system, the method comprising receiving a signal transmitted by a first transceiver by at least two antenna elements of an antenna array of a second transceiver, the antenna elements being used to form at least two receiving beams with different directions; determining signal power values in at least two different receiving beams and a preliminary direction of arrival for the received signal as properties of the received signal, the method further comprising
determining a variable describing the angular speed of the first transceiver in relation to the second transceiver;
performing averaging filtering on at least one of the determined properties and changing at least one parameter of the averaging filtering according to the variable describing the angular speed of the first transceiver; and
determining the direction of the received signal utilizing at least one property filtered with averaging filtering.

2. A method of directing a receiving beam, the method comprising receiving a signal transmitted by a first transceiver by at least two antenna elements of an antenna array of a second transceiver, the antenna elements being used to form at least two receiving beams with different directions; determining signal power values in at least two different receiving beams and a preliminary direction for arrival of the received signal as properties of the received signal, the method further comprising
determining a variable describing the angular speed of the first transceiver in relation to the second transceiver;
performing averaging filtering on at least one of the determined properties, and changing at least one parameter of the averaging filtering according to the variable describing the angular speed of the first transceiver;
determining the direction of the received signal utilizing at least one property filtered with averaging filtering; and
directing at least one receiving beam of the second transceiver by means of the determined direction of arrival.

3. A method according to claim 2, wherein at least one fixed receiving beam is selected for use in reception by means of the determined direction.

4. A method according to claim 2, wherein at least one receiving beam of the second transceiver is directed by factors which shape the antenna pattern with respect to the determined direction of arrival.

5. A method of directing a transmitting beam, the method comprising receiving a signal transmitted by a first transceiver by at least two antenna elements of an antenna array of a second transceiver, the antenna elements being used to form at least two receiving beams with different directions; determining signal power values in at least two different receiving beams and a preliminary direction of arrival for the received signal as properties of the received signal, the method further comprising
determining a variable describing the angular speed of the first transceiver in relation to the second transceiver;
performing averaging filtering on at least one of the determined properties and changing at least one parameter of averaging filtering according to the variable describing the angular speed of the first transceiver;
determining the direction of the received signal utilizing at least one property filtered with averaging filtering; and
directing at least one transmitting beam of the second transceiver by means of the determined direction of arrival.

6. A method according to claim 5, wherein at least one transmitting beam is selected for transmission by the second transceiver by means of the determined direction.

7. A method according to claim 5, wherein at least one transmitting beam of the second transceiver is directed by multipliers shaping the antenna pattern in relation to the determined direction of arrival.

8. A method according to claim 1, 2 or 5, wherein a maximum deviation is set for a change of the direction of arrival; and
the direction of the receiving or transmitting beams of the second transceiver is changed at most by the maximum deviation in connection with the determination of each direction.

9. A method according to claim 1, 2, or 5, wherein the maximum deviation of the direction of arrival is determined according to the angular speed of the first transceiver; and
the direction of the receiving or transmitting beams of the second transceiver is changed at most by the maximum deviation of the direction of arrival in connection with the determination of each direction.

10. A method according to claim 1, wherein the number of the averaging elements used as parameters is changed.

11. A method according to claim 1, wherein the weighting of the elements used as a parameter is changed.

12. A method according to claim 1, wherein a maximum speed is determined for the first transceiver, and the speed is used to determine the variable describing the angular speed.

13. A method according to claim 2 or 5, wherein directions of signals of several first transceivers are determined, the signals comprising desired signals and interfering signals, and directing the null point between the receiving beams of the second transceiver is directed towards at least one of the interfering first transceivers by means of the determined signal directions.

14. A method according to claim 5, wherein directions of signals of several first transceivers are determined, at least one of the first transceivers being interfered with by the transmission of a second transceiver, and the null point between the transmitting beams of the second transceiver is directed towards at least one of the first transceivers interfered with the transmission by means of the determined signal directions.

15. A method according to claim 1, 2 or 5, wherein the distance of the first transceiver from the second transceiver is determined and the determined distance and direction of arrival are used to determine the location of the first transceiver.

16. A method according to claim 1, 2 or 5, wherein, the angular speeds of the first transceiver being divided into angular speed classes, a variable describing the angular speed of the first transceiver is determined as a angular speed class according to which at least one parameter of averaging filtering is changed.

17. A radio system which comprises at least one base station and several terminals, the base station comprises an antenna array which comprises at least two antenna elements, which are arranged to form at least two receiving beams with different directions; the terminal is arranged to function as a transmitter of a signal used in direction determination, and the base station is arranged to function as a receiver of the direction determining signal and receive, using an antenna array, a signal transmitted by the terminal and used in direction determination and, using the antenna array's receiving beams with different directions, determine signal power values in at least two different receiving beams and a preliminary direction of arrival of the signal as properties of the received direction determining signal, wherein
the radio system is arranged to determine a variable describing the angular speed of the terminal in relation to the base station;
the radio system comprises an estimator which performs averaging filtering on at least one of the determined properties; the estimator is arranged to receive information on the variable describing the angular speed of the terminal; and the estimator is arranged to change at least one parameter of averaging filtering according to the variable describing the angular speed of the terminal; and the estimator is arranged to determine the direction of the received signal utilizing at least one property filtered with averaging filtering.

18. A radio system according to claim 17, wherein the estimator is arranged to change the number of averaging elements used as a parameter.

19. A radio system according to claim 17, wherein the estimator is arranged to change the weighting of averaging elements used as a parameter.

20. A radio system according to claim 17, wherein the radio system is arranged to determine a maximum speed for the terminal, which the radio system is arranged to use as a variable describing the angular speed.

21. A radio system according to claim 17, wherein the base station comprises means for directing a receiving beam; the means for directing a receiving beam are arranged to receive information on the determined direction of arrival; and the means for directing a receiving beam are arranged to direct at least one receiving beam by means of the determined direction of arrival.

22. A radio system according to claim 21, wherein the means for directing the receiving beam are arranged to direct at least one receiving beam of the base station by factors shaping the antenna pattern in relation to the determined direction of arrival.

23. A radio system according to claim 21, wherein the means for directing the receiving beam are arranged to select, using the determined direction, at least one receiving beam whose direction deviates least from the determined direction of arrival.

24. A radio system according to claim 17, wherein the base station is arranged to form at least two fixed transmitting beams; the base station comprises means for directing a transmitting beam; the means for directing a transmitting beam are arranged to receive information on the determined direction of arrival; and the means for directing a transmitting beam are arranged to direct at least one transmitting beam by means of the determined direction.

25. A radio system according to claim 24, wherein the means for directing the transmitting beam are arranged to select the transmitting beam; the means for directing the transmitting beam are arranged to receive information on the determined direction of arrival; and the means for directing the transmitting beam are arranged to select at least one transmitting beam by means of the determined direction.

26. A radio system according to claim 24, wherein the means for directing the transmitting beam are arranged to direct at least one transmitting beam of the base station by multipliers shaping the antenna pattern with respect to the determined direction of arrival.

27. A radio system according to claim 17, wherein the radio system is arranged to set a maximum deviation to the direction of arrival between determination of two successive directions of arrival; and
the base station is arranged to change the direction of the transmitting and receiving beams of the base station at most by the maximum deviation in connection with the determination of each direction.

28. A radio system according to claim 17, wherein the radio system is arranged to determine the maximum deviation of the direction of arrival between determination of two successive directions of arrival according to the angular speed of the terminal; and
the base station is arranged to change the direction of the transmitting and receiving beams at most by the maximum deviation of the direction of arrival in connection with the determination of each direction.

29. A radio system according to claim 17, wherein the estimator is arranged to determine the direction of signals of several terminals, the signals including desired signals and interfering signals, and the base station is arranged to direct the null point between the antenna beams towards the interfering terminal by means of the determined signal directions.

30. A radio system according to claim 17, wherein the estimator is arranged to determine the direction of signals of several terminals, of which at least one terminal is interfered with the transmission of the base station; and the base station is arranged to direct the null point between the antenna beams towards the terminal interfered with the transmission by means of the determined signal directions.

31. A radio system according to claim 17, wherein the radio system comprises means for determining the distance of the terminal from the base station; the means for determining the distance of the terminal from the base station are arranged to receive information on the determined direction of arrival; and the means are arranged to determine the location of the terminal by means of the determined distance and direction of arrival.

32. A radio system according to claim 17, wherein, the angular speeds of the terminal being divided into angular speed classes, the estimator is arranged to determine a variable describing the angular speed of the terminal as an angular speed class according to which the estimator is arranged to change at least one parameter of averaging filtering.
